(19) United States
(12) Patent Application Publication
(10) Pub. No.: US 2012/0090438 A1
(43) Pub. Date: Apr. 19, 2012

(54) PLUNGER/CAVITY COOPERATION WITHOUT CREATION OF SUCTION FORCE DURING WITHDRAWAL

(75) Inventors: Jerry Huang, Chung Ho City (TW); J. Y. Ho, Yung Ho City (TW); T. T. Chiu, Tu Cheng City (TW); Chih-Chung Chen, Chung Ho City (TW)

(73) Assignee: TEXAS INSTRUMENTS INCORPORATED, Dallas, TX (US)

(21) Appl. No.: 12/952,932

(22) Filed: Nov. 23, 2010

Related U.S. Application Data
(60) Provisional application No. 61/394,097, filed on Oct. 18, 2010.

(51) Int. Cl. B26D 7/18

(52) U.S. Cl. 83/23; 83/111

(57) ABSTRACT

A cavity for receiving insertion of a plunger is designed so that the plunger may be withdrawn without permitting creation of a suction force sufficient to remove from the cavity a workpiece that the plunger carried into the cavity.

### FIELD OF THE INVENTION

The invention relates generally to cooperation between a plunger and a receiving cavity and, more particularly, to avoiding creation of suction force upon plunger withdrawal.

### BACKGROUND OF THE INVENTION

In conventional integrated circuit (IC) manufacturing, a mold die is used to encapsulate the integrated circuit die in a mold compound (or other similar encapsulant), resulting in an encapsulated IC package. When the encapsulated IC package is removed from the mold die, one or more unwanted remnants of the mold compound typically remain attached to the package, and must be removed. A so-called gate corner slug is a known example of such an unwanted remnant. The gate corner slug is simply residual mold compound that accumulates at the point where the mold die gates the mold compound to the IC die for encapsulation. FIGS. 1 and 2 illustrate a conventional apparatus for removing unwanted remnants such as the gate corner slug. The encapsulated IC package is placed on a die 21 shown in FIGS. 1 and 2, with the remnant overlying a cavity 22 in the die. The remnant is removed by inserting a reciprocating punch 23 into the die cavity 22 as shown in FIG. 2, and thereafter withdrawing the punch 23.

FIG. 3 diagrammatically illustrates the aforementioned remnant removal operation. At 31, the punch 23 is inserted into the die cavity 22 to remove a remnant 32 from a lead frame 33 of an encapsulated IC package. As shown at 34, when the punch 23 is withdrawn from the die cavity 22, suction force 30 created by the withdrawal action may draw the remnant 32 (or at least a portion thereof) out of the die cavity 22, where it may become a cause of damage to leads of the IC package.

According to one conventional technique, the problem illustrated in FIG. 3 may be avoided by increasing vacuum applied below the die 21 sufficiently to counteract the suction force created by punch withdrawal. Disadvantageously, however, the increased vacuum may contribute to damaging the encapsulated IC package while the package is positioned on the die 21.

It is desirable in view of the foregoing to provide for avoiding the aforementioned withdrawn remnant problem without risk of damage to the encapsulated IC package.

### BRIEF DESCRIPTION OF THE DRAWINGS

FIGS. 1-4 illustrate structure, operation and problems associated with cooperable punch and die according to the prior art.

FIGS. 5 and 6 illustrate structure of cooperable punch and die according to exemplary embodiments of the invention.

FIG. 7 illustrates operations that may be performed according to exemplary embodiments of the invention.

### DETAILED DESCRIPTION

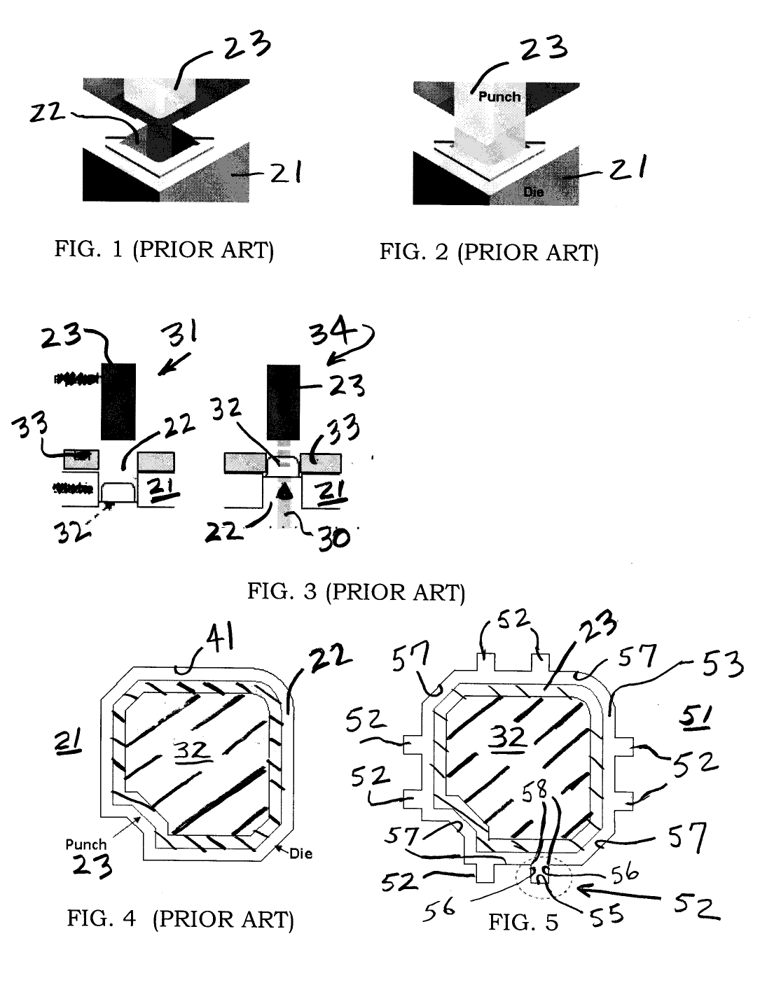

FIG. 4 illustrates an example of the spatial relationship between a punch and cooperating die cavity of the type described above with respect to FIGS. 1-3. As shown in FIG. 4, an interior surface 41 of the die cavity 22 is in relatively close conformal relationship with the inserted punch 23. With the surface 41 closely surrounding the inserted punch 23 as shown, the above-described suction force is created upon withdrawal of the punch 23. Note that FIG. 4 is a view from within the die cavity 22, in the direction of punch withdrawal, and thus shows both the punch 23 and the undesired remnant 32 that the punch carries into the cavity.

FIG. 5 is a view generally similar to that of FIG. 4, but illustrates a die 51 according to exemplary embodiments of the invention. The die 51 has provided therein a die cavity 53 whose interior surface is configured to provide additional air exhaust passages 52 within the die 51. These added air exhaust passages 52 (not shown to scale for all embodiments) serve as auxiliary exhaust paths for pressurized air created by withdrawal of punch 23 from cavity 53. Exhaustion of air through the passages 52 prevents punch withdrawal from creating a suction force sufficient to remove the remnant 32 from the cavity 53.

The interior surface of the die cavity 53 substantially surrounds the inserted punch 23 (in generally similar fashion to the interior die cavity surface 41 of FIG. 4), facing generally transversely to the direction of punch insertion/withdrawal. The interior surface of die cavity 53 includes an inner surface portion 57 that faces the inserted punch 23 and generally conforms to the profile of the punch. The inner surface portion 57 is laterally spaced from the punch 23 by generally the same distance that separates the punch 23 from the interior surface 41 of the die cavity 22 in prior art FIG. 4. The interior surface of the die cavity 53 of FIG. 5 further includes a plurality of sets of further surface portions. Each set of further surface portions defines a corresponding one of the air exhaust passages 52. One such set of further surface portions is identified in detail with respect to the air exhaust passage 52 highlighted in FIG. 5.

In particular, and as demonstrated by the example highlighted in FIG. 5, each air exhaust passage 52 is defined by an outer surface portion 55 and a corresponding pair of connecting surface portions 56. The outer surface portion 55 faces the inserted punch 23, but is located laterally further from the punch than the inner surface portion 57. The connecting surface portions 56 face one another and extend laterally to connect the outer surface portion 55 to the inner surface portion 57. Each of the connecting surface portions 56 joins the inner surface portion 57 to define an edge 58.

In some embodiments, the outer portions 55 and connecting surface portions 56 are generally planar surface portions. In some embodiments, all of the surface portions 55-57 are oriented to extend into the die 51 generally parallel to the insertion/withdrawal direction of the reciprocating punch 23. In some embodiments, each outer surface portion 55 is oriented to be generally parallel to that part of the inner surface portion 57 to which it is connected by its corresponding pair of connecting surface portions 56. In some embodiments, the connecting surface portions 56 are oriented generally parallel to one another, and perpendicularly relative to their corresponding outer surface portion 55.

In various embodiments, the pressure relief operation described above is realized by providing a die cavity having at least one air exhaust passage such as the examples 52 shown in FIG. 5. An air exhaust passage is provided by configuring the interior die cavity surface with an inner surface portion (such as the example 57 of FIG. 5) and an outer surface portion (such as the example 55 in FIG. 5) located further from the inserted punch 23 than the inner surface portion. Although the air exhaust passages 52 in the example of FIG. 5 have generally planar surfaces and a generally rectangular cross-sectional profile, various other embodiments provide one or more air exhaust passage(s), with the passage(s) having various other surface configurations and various other cross-sectional profiles.

FIG. 6 is a pictorial view of the above-described cooperating punch 23 and die 51 with air exhaust passages 52 according to exemplary embodiments of the invention.

Various embodiments apply the above-described techniques with various types of reciprocating plungers that are received in cooperating cavities formed in various types of structures to prevent undesired withdrawal of various types of workpieces.

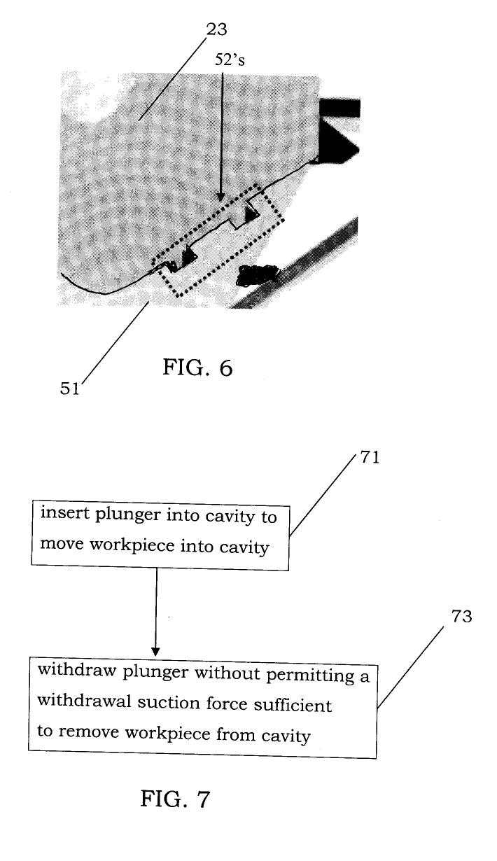

FIG. 7 illustrates operations that may be performed according to exemplary embodiments of the invention. At 71, a plunger is inserted into a cavity to move a workpiece into the cavity. At 73, the plunger is withdrawn without permitting a withdrawal suction force sufficient to remove the workpiece from the cavity.

Although exemplary embodiments of the invention have been described above in detail, this does not limit the scope of the invention, which can be practiced in a variety of embodiments.

What is claimed is:

1. A method of operating a plunger with a cooperating cavity, comprising:
inserting the plunger into the cavity in an insertion direction, including moving a workpiece engaged against the plunger into the cavity in said insertion direction; and
thereafter withdrawing the plunger from the cavity in a withdrawal direction opposite said insertion direction without permitting withdrawal of the plunger to create a suction force in said withdrawal direction sufficient to remove the workpiece from the cavity.

2. The method of claim 1, wherein the workpiece is an undesired remnant of a manufacturing process, wherein the plunger is a punch, and wherein said inserting detaches the undesired remnant from a desired product of the manufacturing process.

3. The method of claim 2, wherein the desired product is an encapsulated object, and the undesired remnant is excess encapsulant.

4. The method of claim 3, wherein the object is an integrated circuit.

5. An apparatus for cooperation with a plunger, comprising:
means defining a cavity for receiving insertion of the plunger, in an insertion direction, with a workpiece engaged against the plunger and carried therewith into said cavity, said cavity having an interior surface that faces generally transversely relative to said insertion direction and substantially surrounds the plunger when the plunger is in said cavity, wherein said interior surface is configured with first and second surface portions such that, when the plunger is in said cavity, said first surface portion is further from the plunger than said second surface portion to provide an air exhaustion path that, upon withdrawal of the plunger from said cavity, prevents creation of a suction force sufficient to remove the workpiece from said cavity.

6. The apparatus of claim 5, wherein the workpiece is an undesired remnant of a manufacturing process, wherein the plunger is a punch, and wherein said insertion detaches the undesired remnant from a desired product of the manufacturing process.

7. The apparatus of claim 6, wherein the desired product is an encapsulated object, and the undesired remnant is excess encapsulant.

8. The apparatus of claim 7, wherein the object is an integrated circuit.

9. The apparatus of claim 5, wherein said first surface portion is a generally planar surface portion.

10. The apparatus of claim 9, wherein said interior surface is configured with a plurality of said first surface portions to provide a plurality of said air exhaustion paths.

11. The apparatus of claim 5, wherein said interior surface is configured with a plurality of said first surface portions to provide a plurality of said air exhaustion paths.

12. The apparatus of claim 5, wherein said interior surface is configured with an edge between said first and second surface portions.

13. The apparatus of claim 12, wherein said interior surface is configured with a third surface portion between said edge and said first surface portion.

14. An apparatus for moving a workpiece, comprising:
a plunger for engagement with the workpiece, said plunger supported for reciprocating movement; and
means defining a cavity for receiving insertion of said plunger, in an insertion direction, with the workpiece engaged against said plunger and carried therewith into said cavity, said cavity having an interior surface that faces generally transversely relative to said insertion direction and substantially surrounds said plunger when said plunger is in said cavity, wherein said interior surface is configured with first and second surface portions such that, when said plunger is in said cavity, said first surface portion is further from said plunger than said second surface portion to provide an air exhaustion path that, upon withdrawal of said plunger from said cavity, prevents creation of a suction force sufficient to remove the workpiece from said cavity.

15. The apparatus of claim 14, wherein the workpiece is an undesired remnant of a manufacturing process, wherein the plunger is a punch, and wherein said insertion detaches the undesired remnant from a desired product of the manufacturing process.

16. The apparatus of claim 15, wherein the desired product is an encapsulated object, and the undesired remnant is excess encapsulant.

17. The apparatus of claim 16, wherein the object is an integrated circuit.

18. The apparatus of claim 14, wherein said first surface portion is a generally planar surface portion.

19. The apparatus of claim 18, wherein said interior surface is configured with a plurality of said first surface portions to provide a plurality of said air exhaustion paths.

20. The apparatus of claim 14, wherein said interior surface is configured with a plurality of said first surface portions to provide a plurality of said air exhaustion paths.

21. The apparatus of claim 14, wherein said interior surface is configured with an edge between said first and second surface portions.

22. The apparatus of claim 21, wherein said interior surface is configured with a third surface portion between said edge and said first surface portion.
